(19) United States
(12) Patent Application Publication
(10) Pub. No.: US 2026/0038321 A1
(43) Pub. Date: Feb. 5, 2026

(54) EMERGENCY DOOR OPENING APPARATUS

(71) Applicant: Matrix Research Limited, Hong Kong (CN)

(72) Inventor: Shing Kwong Fung, Tsuen Wan (CN)

(73) Assignee: Matrix Research Limited, Hong Kong (CN)

(21) Appl. No.: 18/909,954

(22) Filed: Oct. 9, 2024

(30) Foreign Application Priority Data
Jul. 31, 2024 (TW) 113208182

(51) Int. Cl. G07C 9/00

(52) U.S. Cl. CPC G07C 9/00944; G07C 9/00182; G07C 2009/00214; G07C 2009/00642

(57) ABSTRACT

An emergency door opening apparatus includes a trigger portion, a resisting portion, a sensor; a switch, wherein when a user presses the push portion, the buckling portion will engage with the trigger portion so as to trigger the trigger portion to a trigger position. At his moment, the sensor will detect the state and emits signals to the switch so that the switch to cut off the connection of the external power source and thus the door lock is unlocked and thus is opened. This device is suitable to the emergency state. It is only needed to press the push portion for rescue. The operation is quick and convenient.

### FIELD OF THE INVENTION

The present invention is related to emergency devices, and in particular to an emergency door opening apparatus.

### BACKGROUND OF THE INVENTION

The prior art electric control door lock includes a card reader for receiving identification data for a person entering into the door and transferring the data to another device so that the device can identify the identification data to make sure that the person is a permissible one for opening or closing the door. When the device assures that the person is a permissible one, a door lock for opening or closing the door is actuated. The door lock includes a magnet and a door lock. When the magnet is conducted, it will actuate the door lock to open or close the door.

In emergency state, to use the card reader for opening the door is not practical, because this will induce that the persons cannot run away immediately. In the prior art, an emergency rescue device with a glass panel is disclosed. In emergency sate, person can break the glass panel for pushing an emergency button after the glass panel. However, this design has the danger that the user will be hurt due to breaking of the glass. Furthermore, since the glass is broken, it can not be reused. Therefore, this design is not practical.

### SUMMARY OF THE INVENTION

Accordingly, the object of the present invention is to provide an emergency door opening apparatus wherein advantages of the present invention are that the present invention uses simple components. When a user presses the push portion, the buckling portion will engage with the trigger portion so as to trigger the trigger portion to a trigger position. At his moment, the sensor will detect the state and emits signals to the switch so that the switch to cut off the connection of the external power source and thus the door lock is unlocked and thus is opened. This device is suitable to the emergency state. It is only needed to press the push portion for rescue. The operation is quick and convenient.

To achieve above object, the present invention provides an emergency door opening apparatus, which is used to the operation of a door lock of a door; the door lock includes an electric lock; if the electric lock is actuated, a door opening unit connected to the electric lock will be energized or released so as to open or close the door; the emergency door opening apparatus comprising: a trigger portion including a trigger post and a push portion at an upper end of the trigger post; pushing the trigger portion causing movement of the trigger post; a resilient device coupling with the trigger portion for restoring the trigger portion to an initial position; wherein the trigger post being a trigger tube; a side of the trigger post is formed with a buckling portion; the buckling portion is a recess which is formed at one side of the trigger post; a resisting portion for controlling a movement of the trigger post; in emergency state, the trigger portion is pressed to move downwards so that one end of the resisting portion will engage with the buckling portion so that the trigger portion is fixed to a trigger position; a sensor; when the trigger portion being triggered, the sensor will be actuated to output sensed signals; a switch positioned between the door lock of the door and an external power source; then external power source being connected to the door lock by an electric wire; the switch being at the electric wire for switching the power flow in the electric wire to the door lock; the switch being further connected to the sensor which can control the switching of the switch; and wherein when the trigger portion is in a trigger position, the sensor will transfer a detected current to the switch so that the switch is cut off to be disconnected with the external power supply and thus the door lock does not conduct, as a result, the door is opened; the door opening unit is open or close the door lock; when the door opening unit has no power supply, the door open unit will release so that the door is opened.

### BRIEF DESCRIPTION OF THE DRAWINGS

FIG. 1 is a block diagram about the elements of the present invention.

FIG. 2 shows one embodiment of the present invention.

FIG. 3 shows another embodiment of the present invention, where the trigger portion is in an initial position.

FIG. 4 is a schematic view showing the structure of the main box of the present invention.

FIG. 5 is a schematic view showing the combination of the main box.

FIG. 6 shows another embodiment of the present invention, wherein the trigger portion is in an initial position.

FIG. 7 shows another embodiment of the present invention, wherein the trigger portion is in a trigger position.

FIG. 8 shows another embodiment of the present invention, wherein the trigger portion is restored to an initial position by the action of the restoring portion.

FIG. 9 shows a further embodiment of the present invention, wherein the trigger portion is restored to an initial position by the action of the restoring portion.

FIG. 10 shows an application of the present invention, wherein the switch is in an open state.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

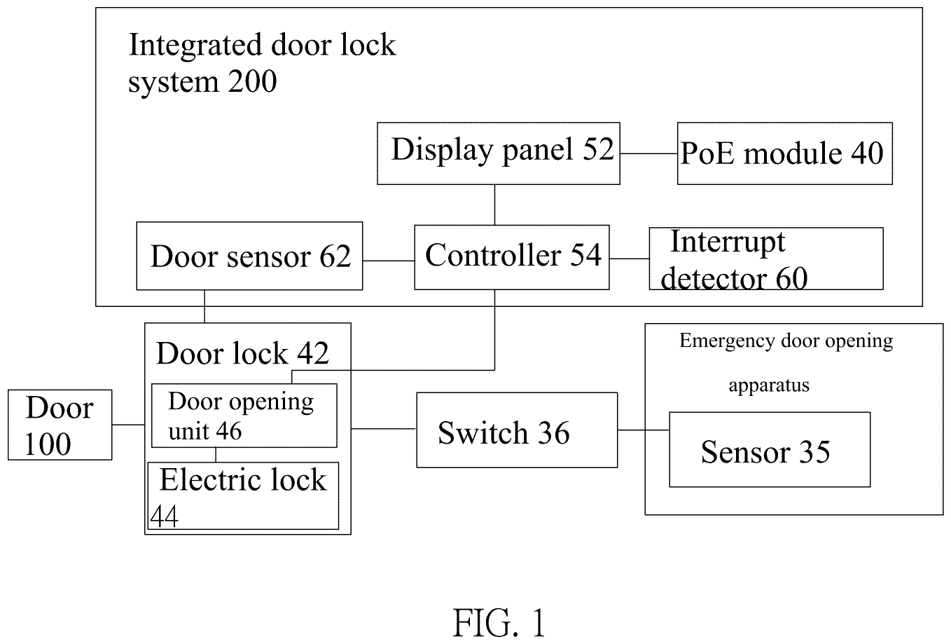

Referring to FIGS. 1 to 10, the emergency door opening apparatus of the present invention is illustrated. The present invention is used to the operation of a door lock 42 of a door 100. The door lock 42 includes an electric lock 44. If the electric lock 44 is actuated, a door opening device 46 (such as a door magnetic) connected to the electric lock 44 will be energized or released so as to open or close the door 100.

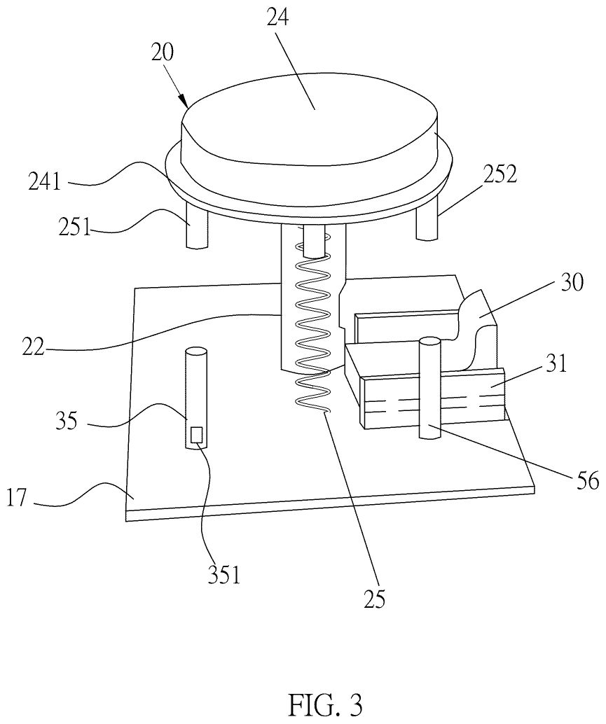

With reference to FIGS. 3 to 9, the emergency door opening apparatus of the present invention includes the following elements.

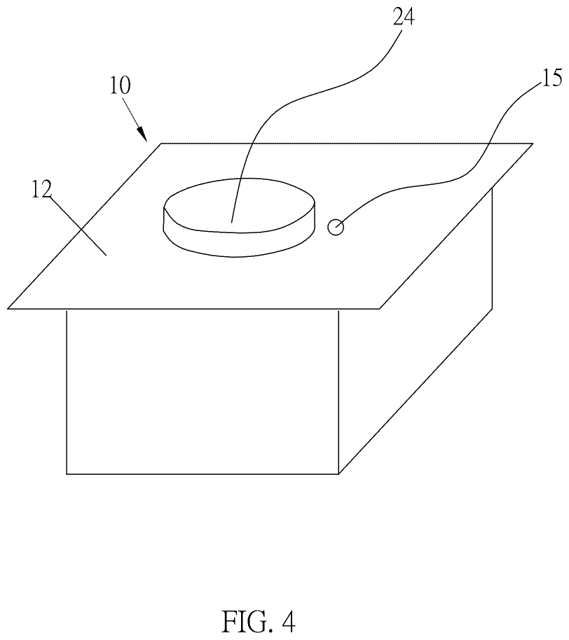

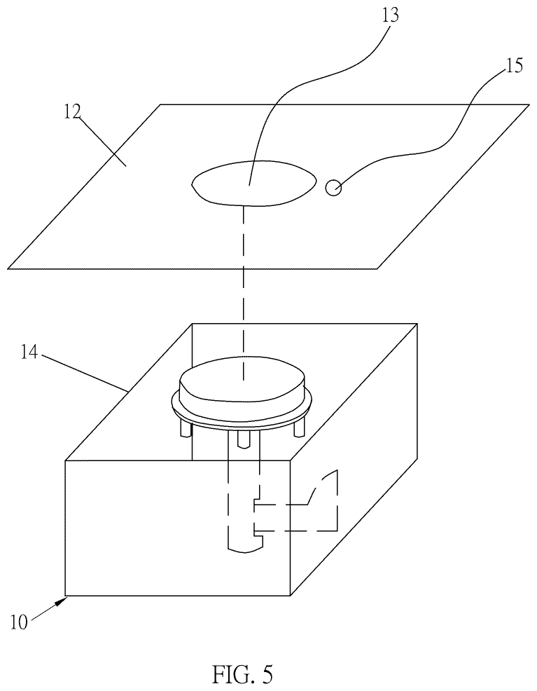

A main box 10 has an upper opening 14 and an upper covering sheet 12 covering upon the upper opening 14. The upper covering sheet 12 has a penetrating hole 13 and a restoring hole 15 which are communicated to the upper opening 14 (referring to FIGS. 4 and 5).

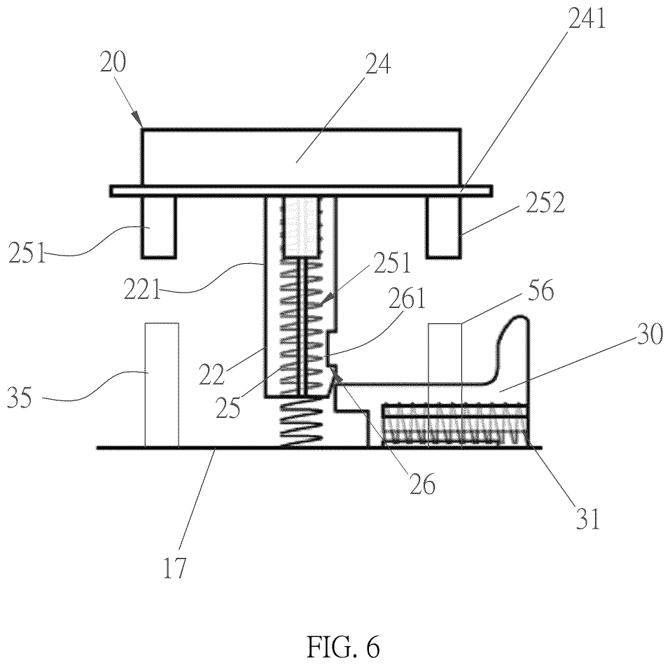

A trigger portion 20 includes a trigger post 22 and a push portion 24 at an upper end of the trigger post 22. Pushing the trigger portion 20 causes the movement of the trigger post 22, as illustrated in FIGS. 3 and 6. A resilient device 25 couples with the trigger portion 20 for restoring the trigger portion 20 to an initial position. In non-emergency state, the trigger portion 20 is at an initial position, as shown in FIG. 6.

The trigger post 22 is a trigger tube 221 within the main box 10. A side of the trigger post 22 is formed with a buckling portion 26. The buckling portion 26 is a recess 261 which is formed at one side of the trigger post 22 (referring to FIG. 6). An upper end of the push portion 24 exposes from the upper cover 14 of the main box 10 and the penetrating hole 13 of the upper covering sheet 12 (referring to FIG. 4)

The resilient device 25 is a spring 251 installed within the trigger post 22. Two ends of the spring 251 are fixed so that it can compress or resilient to cause up and down movements of the spring 251. For example, an upper end of the spring 251 is fixed to the trigger portion 20 and the lower end thereof is fixed to a bottom surface 17.

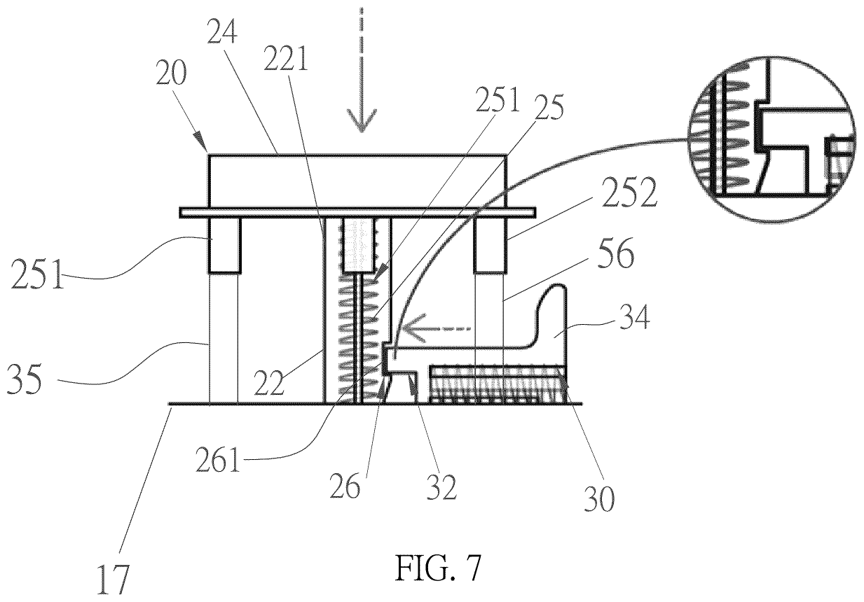

A resisting portion 30 serves for controlling a movement of the trigger post 22, as shown in FIG. 6. In emergency state, the trigger portion 20 is pressed to move downwards so that one end of the resisting portion 30 will engage with the buckling portion 26 so that the trigger portion 20 is fixed to a trigger position (referring to FIG. 7).

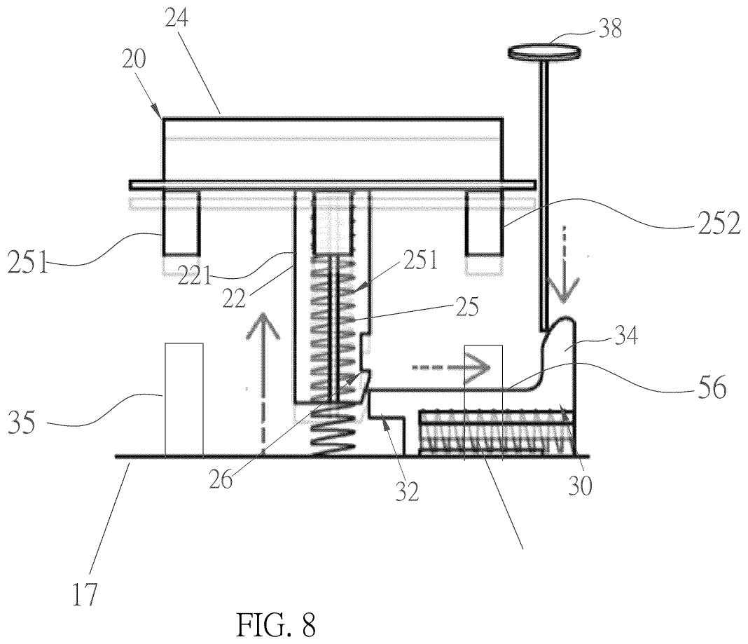

Referring to FIGS. 7 and 8, it is illustrated that resisting portion 30 is a post-like structure. One end of the resisting portion 30 is formed as an engaging portion 32 for engaging with the buckling portion 26, and another end thereof extends upwards to be formed as a restoring portion 34.

When the trigger portion 20 is triggered to move downwards, the resisting portion 30 will move toward the recess 261 to be resisted against an edge of the recess 261 so that the trigger post 22 buckles at a trigger position. When the resisting portion 30 releases from the buckling portion 26, the resilient device 25 restores the trigger portion 20 to the initial position.

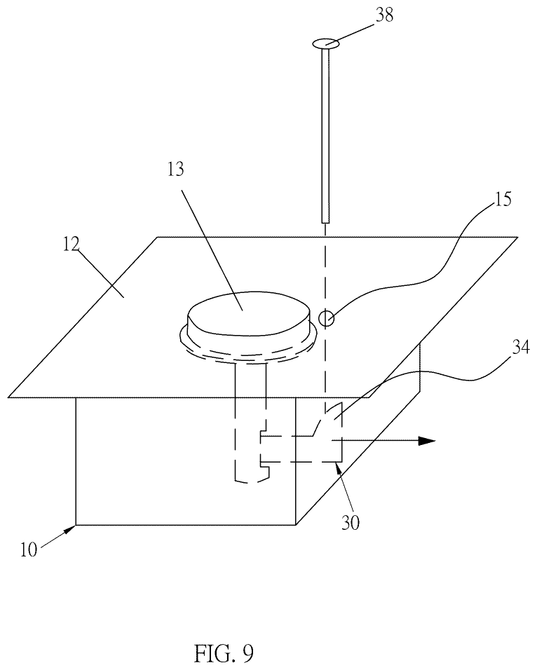

A restoring unit 38 is a post like device which can pass through the restoring hole 15 of the upper covering sheet 12 to contact the restoring portion 34 so that the restoring unit 38 pushes the restoring portion 34 to the original position. Therefore, the trigger portion 20 restores to the initial position, as illustrated in FIGS. 8 and 9.

In this application, the restoring portion 34 is reduced from upper end toward lower end. However, this form is not used to confine the scope of the present invention. Other forms of the restoring portion 34 which can achieve the object of restoring the trigger portion 20 to the initial position is within the scope of the present invention.

In the present invention, the resisting portion 30 is installed along a guide unit 31 which is fixed to the bottom surface 17 of the main box 10 so that the resisting portion 30 moves with respect to the main box 10. The guide unit 31 is, for example, a track or a spring.

A sensor 35 is on the bottom surface 17. When the trigger portion 20 is triggered, the sensor 35 will be actuated to output sensed signals, for example, when the trigger portion 20 moves down to trigger a piezoelectric convertor 351 in the sensor 35, the contact pressure will be converted into the current.

Referring to FIG. 6, in the present invention, the push portion 24 is an enlarged plate 241 extended from the trigger post 22 and a lower end of the push portion 24 extends with a sensing post 251 which is located at a position corresponding to the senor 25 on the bottom surface 17. When the trigger portion 20 presses downwards, the sensing post 251 will contact the piezoelectric convertor 351 (referring to FIG. 7) so as to generate current.

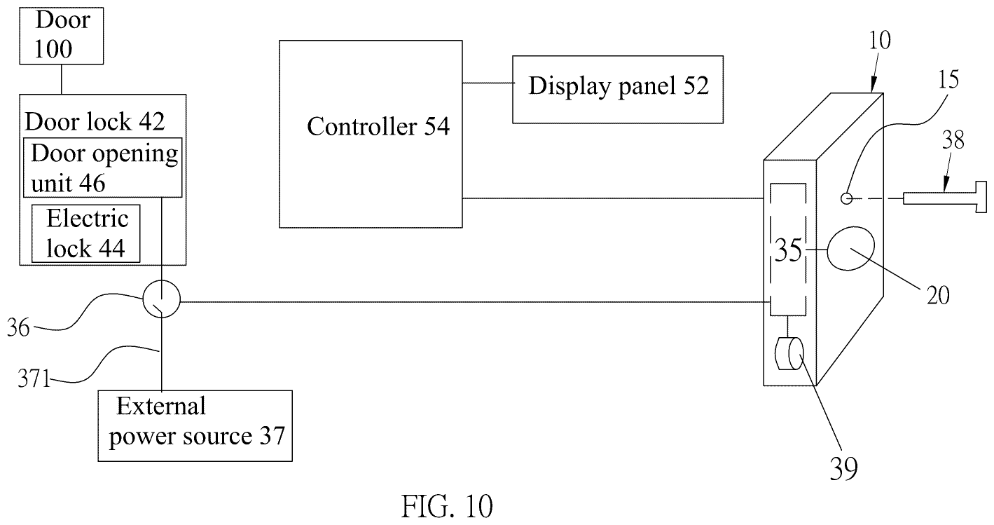

A switch 36 is positioned between the door lock 42 of the door 100 and an external power source 37 (referring to FIG. 10). Then external power source 37 is connected to the door lock 42 by an electric wire 371. The switch 36 is at the electric wire 371 for switching the power flow in the electric wire 371 to the door lock 42. The switch 36 is further connected to the sensor 35 which can control the switching of the switch 36.

A battery 39 is connected to the sensor 35 for supplying power thereto.

When the trigger portion 20 is in a trigger position, the sensor 35 will transfer a detected current to the switch 36 so that the switch 36 is cut off to be disconnected with the external power supply 37 so that the door lock does not conduct, as a result, the door 100 is opened. A door opening unit 46 is, for example, used to open or close the door lock 42. When the door opening unit 46 has no power supply, the door open unit 46 will release so that the door 100 is opened.

In the following, an integrated door lock system 200 is described.

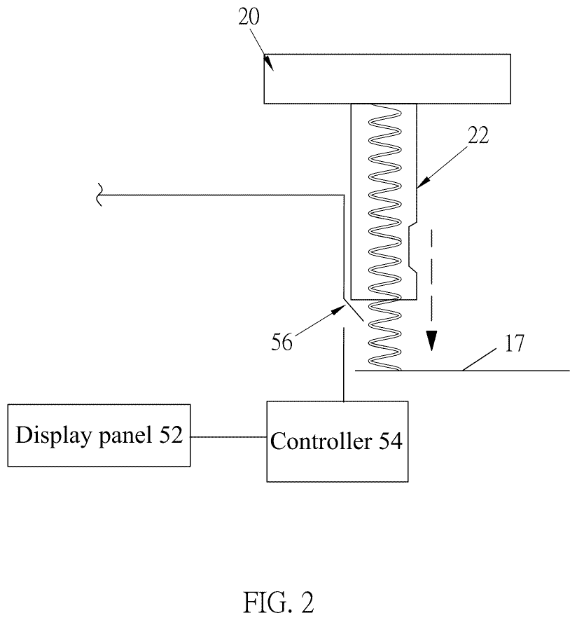

The present invention further includes a display panel 52 which is connected to a controller 54. The display panel 52 serves to display the state of the trigger portion 20. When the trigger portion 20 is triggered, a joint 56 is actuated so as to generate an actuated signal which is transferred to the controller 54 so that the controller 54 can display the state of the trigger portion 20 on the display panel 52, as illustrated in FIG. 2.

Referring to FIG. 6, a lower end of the push portion 24 extending with a joint post 252 which is corresponding to the joint 56 on the bottom surface 17. When the trigger portion 20 is pressed, the joint post 252 contacts the joint 56 (referring to FIG. 7) so that the joint 56 is actuated to generate an actuation signal to the controller 54. Therefore, the controller 54 knows this state which is displayed on the display panel 52. Other similar structures are within the scope of the present invention.

Referring to FIG. 1, the present invention further includes:

An interrupt detector 60 which is connected to the controller 54. The detector 60 could emit electromagnetic waves, which the wave is interrupted, the detector 60 will detect this state, for example, by detecting reflecting wave of the electromagnetic waves. The electromagnetic wave is RF waves, infrared waves, laser waves, etc.

The controller 54 is connected to the interrupt detector 60 and the door lock 42. In the present invention, the controller 54 is mainly connected to the door switch unit 46 of the door lock 42. The controller 54 receives the input signals from the interrupt detector 60 for determining whether anyone enters into or leaves from the door.

The present invention further includes a door sensor 62 which is connected to the controller 54 and the door lock 42 for receiving identification signals of a person desire to enter into the door and transferring the signals to rear end devices, as illustrated in FIG. 1 so as to determine whether the door is necessary to be opened or closed. In the present invention, the door sensor 62 may be selected from card readers, biological sensors, such as finger textures sensors, face detectors, eye detectors, voice detectors, palmar digital veins detectors, etc., or electromagnetic detectors, such as blue tooth detectors, NFC, etc.

The controller 54 further receives signals from the door sensor 62 for determining whether the persons desire entering to the door are permissible and generating electric signals to actuate the door lock 42, in the present invention, it is to actuate the door switch unit 46.

A PoE module 40 (Power over Ethernet PD module) is connected to the network through a PoE cable or a PoE+ cable (not shown) for getting electric power through the network and transferring the power to lower voltage current, such as 12 V current. In FIG. 1, it is illustrated that the PoE cable is connected to the display panel 52, however this is only an example for description, the PoE could be connected to various devices for supply electric power.

Advantages of the present invention are that the present invention uses simple components. When a user presses the push portion, the buckling portion will engage with the trigger portion so as to trigger the trigger portion to a trigger position. At his moment, the sensor will detect the state and emits signals to the switch so that the switch to cut off the connection of the external power source and thus the door lock is unlocked and thus is opened. This device is suitable to the emergency state. It is only needed to press the push portion for rescue. The operation is quick and convenient.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An emergency door opening apparatus, which is used to the operation of a door lock of a door; the door lock includes an electric lock; if the electric lock is actuated, a door opening unit connected to the electric lock will be energized or released so as to open or close the door; the emergency door opening apparatus comprising:
a trigger portion including a trigger post and a push portion at an upper end of the trigger post; pushing the trigger portion causing movement of the trigger post; a resilient device coupling with the trigger portion for restoring the trigger portion to an initial position; wherein the trigger post being a trigger tube; a side of the trigger post is formed with a buckling portion; the buckling portion is a recess which is formed at one side of the trigger post;
a resisting portion for controlling a movement of the trigger post; in emergency state, the trigger portion is pressed to move downwards so that one end of the resisting portion will engage with the buckling portion so that the trigger portion is fixed to a trigger position;
a sensor; when the trigger portion being triggered, the sensor will be actuated to output sensed signals;
a switch positioned between the door lock of the door and an external power source; then external power source being connected to the door lock by an electric wire; the switch being at the electric wire for switching the power flow in the electric wire to the door lock; the switch being further connected to the sensor which can control the switching of the switch; and
wherein when the trigger portion is in a trigger position, the sensor will transfer a detected current to the switch so that the switch is cut off to be disconnected with the external power supply and thus the door lock does not conduct, as a result, the door is opened; the door opening unit is open or close the door lock; when the door opening unit has no power supply, the door open unit will release so that the door is opened.

2. The emergency door opening apparatus as claimed in claim 1, wherein the resilient device is a spring installed within the trigger post; two ends of the spring are fixed so that it can compress or resilient to cause up and down movements of the spring.

3. The emergency door opening apparatus as claimed in claim 1, further comprising a main box which has an upper opening and an upper covering sheet covering upon the upper opening; wherein the upper covering sheet has a penetrating hole and a restoring hole which are communicated to the upper opening; and
an upper end of the push portion exposing from the upper cover of the main box and the penetrating hole of the upper covering sheet.

4. The emergency door opening apparatus as claimed in claim 3, wherein the resisting portion is a post-like structure; one end of the resisting portion is formed as an engaging portion for engaging with the buckling portion, and another end thereof extends upwards to be formed as a restoring portion; and
wherein when the trigger portion is triggered to move downwards, the resisting portion moves toward the recess to be resisted against an edge of the recess so that the trigger post buckles at a trigger position; and when the resisting portion releases from the buckling portion, the resilient device restores the trigger portion to the initial position.

5. The emergency door opening apparatus as claimed in claim 4, further comprising a restoring unit which is a post like device which can pass through the restoring hole of the upper covering sheet to contact the restoring portion so that the restoring unit pushes the restoring portion to the original position.

6. The emergency door opening apparatus as claimed in claim 5, wherein the restoring portion is reduced from upper end toward lower end.

7. The emergency door opening apparatus as claimed in claim 1, wherein the push portion is an enlarged plate extended from the trigger post and a lower end of the push portion extends with a sensing post which is located at a position corresponding to the senor on the bottom surface; when the trigger portion presses downwards, the sensing post will contact the piezoelectric convertor so as to generate current.

8. The emergency door opening apparatus as claimed in claim 3, wherein the resisting portion is installed along a guide unit which is fixed to the bottom surface of the main box so that the resisting portion moves with respect to the main box; the guide unit is selected from a track and a spring.

9. The emergency door opening apparatus as claimed in claim 1, further comprising a display panel which is connected to a controller; the display panel serves to display the state of the trigger portion; when the trigger portion is triggered, a joint is actuated so as to generate an actuated signal which is transferred to the controller so that the controller can display the state of the trigger portion on the display panel.

10. The emergency door opening apparatus as claimed in claim 9, wherein a lower end of the push portion extends with a joint post which is corresponding to the joint on the bottom surface; when trigger portion is pressed, the joint post contacts the joint so that the joint is actuated to generate an actuation signal to the controller; and therefore, the controller knows this state which is displayed on the display panel.

11. The emergency door opening apparatus as claimed in claim 9, wherein further comprising:
an interrupt detector which is connected to the controller; the detector can emit electromagnetic waves, which the wave is interrupted, the detector will detect this state, wherein the controller is connected to the door switch unit of the door lock; the controller receives the input signals from the interrupt detector for determining whether anyone enters into or leaves from the door.

12. The emergency door opening apparatus as claimed in claim 11, further comprise a door sensor which is connected to the controller and the door lock for receiving identification signals of a person desire to enter into the door and transferring the signals to rear end devices to determine whether the door is necessary to be opened or closed; the door sensor is selected from card readers, biological sensors, finger textures sensors, face detectors, eye detectors, voice detectors, palmar digital veins detectors, etc., or electromagnetic detectors including blue tooth detectors, NFC, etc; and
Wherein the controller further receives signals from the door sensor for determining whether the persons desire entering to the door are permissible and generating electric signals to actuate the door lock.

13. The emergency door opening apparatus as claimed in claim 11, further comprising a PoE module (Power over Ethernet PD module) which is connected to the network through a PoE cable or a PoE+ cable for getting electric power through the network and transferring the power to lower voltage current.

14. The emergency door opening apparatus as claimed in claim 1, wherein a battery is connected to the sensor for supplying power thereto.
